(19) United States
(12) Patent Application Publication
(10) Pub. No.: US 2021/0303301 A1
(43) Pub. Date: Sep. 30, 2021

(54) Program Execution Assistance Apparatus and Program Execution Assistance Method

(71) Applicant: Hitachi, Ltd., Tokyo (JP)

(72) Inventor: Kazuhito YOKOI, Tokyo (JP)

(21) Appl. No.: 17/024,275

(22) Filed: Sep. 17, 2020

(30) Foreign Application Priority Data
Mar. 31, 2020 (JP) 2020-062980

(51) Int. Cl. G06F 9/30; G06F 9/38

(52) U.S. Cl. CPC G06F 9/3005; G06F 9/3836; G06F 9/3001

(57) ABSTRACT

A program creation assistance apparatus includes an arithmetic device that executes a flow data acquisition process for acquiring information of an execution target process and attribute information of the process, an environment determination process for determining an environment for executing the execution target process based on a predetermined rule that defines a relationship between a predetermined process and an environment for executing the predetermined process, and the acquired attribute information, and a registration process for transmitting, to the determined environment, information for executing a program that realizes the execution target process in the environment.

### CROSS-REFERENCE TO RELATED APPLICATION

This application claims priority pursuant to 35 U.S.C. § 119 from Japanese Patent Application No. 2020-062980, filed on Mar. 31, 2020, the entire disclosure of which is incorporated herein by reference.

### BACKGROUND OF THE INVENTION

### 1. Field of the Invention

The present invention relates to a program execution assistance apparatus and a program execution assistance method.

### 2. Description of the Related Art

A cloud system is provided with development environments such as IaaS (Infrastructure as a Service) and PaaS (Platform as a Services), and application developers can develop and execute programs (applications) using these development environments.

In recent years, FaaS (Function as a Service), which is a serverless environment for efficiently using server resources used by executed programs, has been attracting attention. In the serverless environment, an application developed by an application developer can be periodically executed, or the serverless environment can be periodically called through access to a REST API (REpresentational State Transfer Application Programming Interface).

Such a serverless environment is particularly suitable when the program to be executed is a stateless program in which there is no state exchange among a plurality of service functions. Executing a stateless program has a merit on that the processes of the program can be scaled in addition to making server resources more efficient. Therefore, the serverless environment is suitable for a regular batch process that handles large amounts of data, and a REST API process for backend servers that you want to scale as the number of users increases.

On the other hand, visual programming is attracting attention as a programming technique in recent years. The visual programming is not a method of developing a program by a coding operation that inputs a character string, but a development method of developing it by combining processing blocks that are visually easy to understand. This visual programming has the feature that an idea can be easily implemented even by a person who does not have coding ability. Further, even an engineer having a coating ability has an advantage that a bug caused by an erroneous input of source code can be minimized and a prototype can be rapidly developed.

There is an attempt to operate a program developed by the visual programming in a serverless environment. In the document “OpenWhisk processing block: Execute JavaScript code described in processing block in serverless environment” ([online], [Search on February 28, Reiwa 2], Internet <URL:https://flows.nodered.org/node/node-red-node-openwhisk>), there is provided a method of preparing a processing block for coding in the visual programming and registering the source code described in this processing block as a serverless function in a serverless environment. In the development environment of this method, a plurality of processing blocks are executed in an order specified by the user, and the serverless function is called when the executed processing block reaches the processing block registered in the serverless environment.

In the document “Lambda request/response processing block: execute the flow placed between the Lambda request processing block and the Lambda response processing block in a serverless environment” ([online], [February 28, Reiwa 2 Search], Internet <URL:https://docs.enebular.com/ja/deploy/deployflow/lambda>), there is disclosed a method of adding a processing block at a starting point and a processing block at an ending point to be registered in a serverless environment to a series of processing including a plurality of processing blocks.

In this method, all processing blocks are collectively registered in the serverless environment. The serverless environment recognizes a series of processing blocks to be executed in the serverless environment based on the starting point and ending point information of the processing blocks.

However, the methods of both documents are effective when a developer newly develops an application and executes it in a serverless environment. However, if the developer wants to execute the programs of the applications developed and accumulated in the past in the serverless environment, all the applications must be modified to operate in the serverless environment, and thus the number of development man-hours increases.

In this case, in the serverless implementation, there is a possibility that the demerit that the number of development man-hours increases becomes larger than the above-mentioned merit such as efficient use of resources or scaling. As described above, it is not easy to properly use the serverless environment and the runtime environment.

### SUMMARY

The invention has been made in view of such a current situation, and an object thereof is to provide a program execution assistance apparatus and a program execution assistance method capable of executing desired processes in an environment in which it can be efficiently executed.

According to one aspect of the invention for solving the above-mentioned problem, there is provided a program execution assistance apparatus which includes an arithmetic device that executes a flow data acquisition process for acquiring information of an execution target process and attribute information of the process, an environment determination process for determining an environment for executing the execution target process based on a predetermined rule that defines a relationship between a predetermined process and an environment for executing the predetermined process, and the acquired attribute information, and a registration process for transmitting, to the determined environment, information for executing a program that realizes the execution target process in the environment.

According to another aspect of the invention for solving the above-mentioned problem, there is provided a program execution assistance method in which an information processing apparatus executes a program execution assistance method that executes a flow data acquisition process for acquiring information of an execution target process and attribute information of the process, an environment determination process for determining an environment for executing the execution target process based on a predetermined rule that defines a relationship between a predetermined process and an environment for executing the predetermined process, and the acquired attribute information, and a registration process for transmitting information to the determined environment to execute a program that realizes the execution target process in the environment.

According to the invention, it is possible to execute a desired process in an efficient execution environment.

Objects, configurations, and effects besides the above description will be apparent through the explanation on the following embodiments.

### BRIEF DESCRIPTION OF DRAWINGS

FIG. 1 is a diagram illustrating an example of a configuration of a program execution assistance system of this embodiment;

FIG. 2 is a diagram for explaining an example of the hardware configuration and functions of the program conversion apparatus;

FIG. 3 is a diagram for explaining an example of the hardware configuration and functions of a runtime environment;

FIG. 4 is a diagram for explaining an example of the hardware configuration and functions of a serverless environment;

FIG. 5 is a diagram illustrating an example of the hardware configuration and functions of a flow editor environment;

FIG. 6 is a diagram illustrating an example of a serverless implementation rule;

FIG. 7 is a flowchart for explaining an example of a serverless implementation process; and

FIG. 8 is a diagram for explaining an outline of an example of a conventional program execution assistance system.

### DESCRIPTION OF EMBODIMENTS

Hereinafter, a program execution assistance method of this embodiment will be described with reference to the drawings.

<Conventional Program Execution Assistance System>

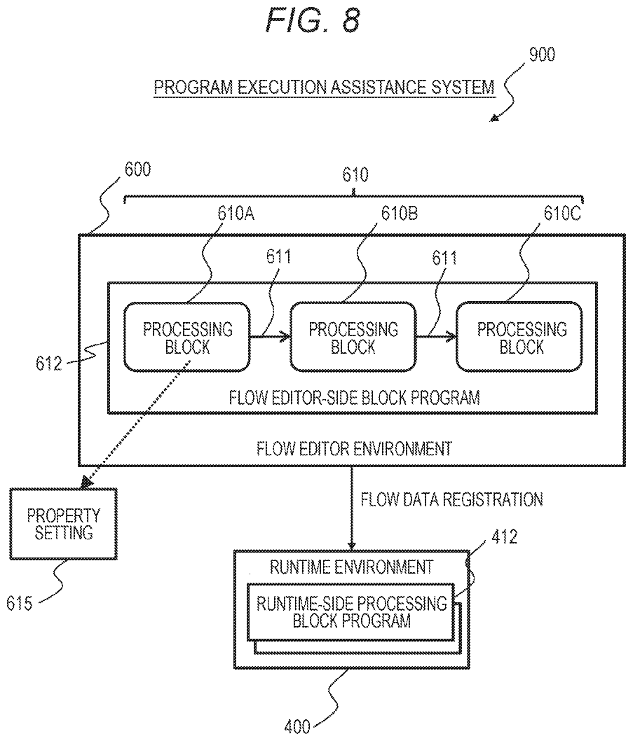

First, FIG. 8 is a diagram for explaining an outline of an example of a conventional program execution assistance system 900. The program execution assistance system 900 includes a flow editor environment 600 and a runtime environment 400. The flow editor environment 600 and the runtime environment 400 are information processing systems each including one or more information processing apparatuses. The flow editor environment 600 and the runtime environment 400 are communicatively connected.

The flow editor environment 600 is used by a user who develops a predetermined program using the runtime environment 400. The flow editor environment 600 stores a flow editor-side processing block program 612 that uses a user interface.

The flow editor-side processing block program 612 displays one or a plurality of processing blocks 610 representing a predetermined processing by a user operation on a screen (three processing blocks 610A, 610B, and 610C in the drawing). Each processing block 610 is displayed as an icon, for example. The processing block 610 represents a runtime-side processing block program 412 stored in the runtime environment 400, which will be described below.

Further, the flow editor-side processing block program 612 displays, on the screen, a connection FIG. 611 (a line segment or the like) connecting from one processing block 610 to another processing block 610 among the processing blocks 610 displayed on a screen is displayed by a user operation.

The processing blocks 610 are ordered by the connection FIG. 611. The runtime-side processing block programs 412 corresponding to the processing blocks 610 are executed in the runtime environment 400 in the order indicated by the connection FIG. 611.

Further, the flow editor-side processing block program 612 displays a setting screen 615 for setting the attribute information (property) of each processing block 610 displayed on the screen by a user operation.

The property is attribute information of the runtime-side processing block program 412 corresponding to the processing block 610. The property is, for example, information indicating the timing of executing the runtime-side processing block program 412, and information such as an access destination of data acquired or written by the runtime-side processing block program 412.

The flow editor-side processing block program 612 transmits, to the runtime environment 400, data (flow data) which includes information for specifying each processing block 610 displayed on the screen in response to an execute instruction input by the user (that is, information for specifying the runtime-side processing block program 412; hereinafter, referred to as block specifying information), information about the order among the processing blocks 610 (hereinafter, referred to as order information), and information about the property of each processing block 610 (hereinafter, referred to as property information).

The runtime environment 400 is a dedicated server provided corresponding to the flow editor environment 600. The runtime environment 400 stores the runtime-side processing block program 412, which is a program corresponding to the processing block 610, in advance.

When receiving the flow data (execute instruction) from the flow editor environment 600, the runtime environment 400 executes each runtime-side processing block program 412 in the order indicated by the order information based on the received flow data. At this time, each runtime-side processing block program 412 executes each process based on the property information of each runtime-side processing block program 412.

As described above, according to the program execution assistance system 900, the user can visually set the runtime-side processing block program 412 to be executed, the property, and the execution order thereof using the flow editor environment 600.

However, in recent years when serverless implementation is progressing, there is an increasing need to execute the flow of the processing block 610 created using the flow editor environment 600 not only in the runtime environment 400 but also in the serverless environment (cloud or the like).

Therefore, a program execution assistance system 1 according to this embodiment described below appropriately performs the process related to the processing block 610 in the flow created in the flow editor environment 600 by performing a predetermined conversion process on the flow data in the serverless environment.

<Program Execution Assistance System of this Embodiment>

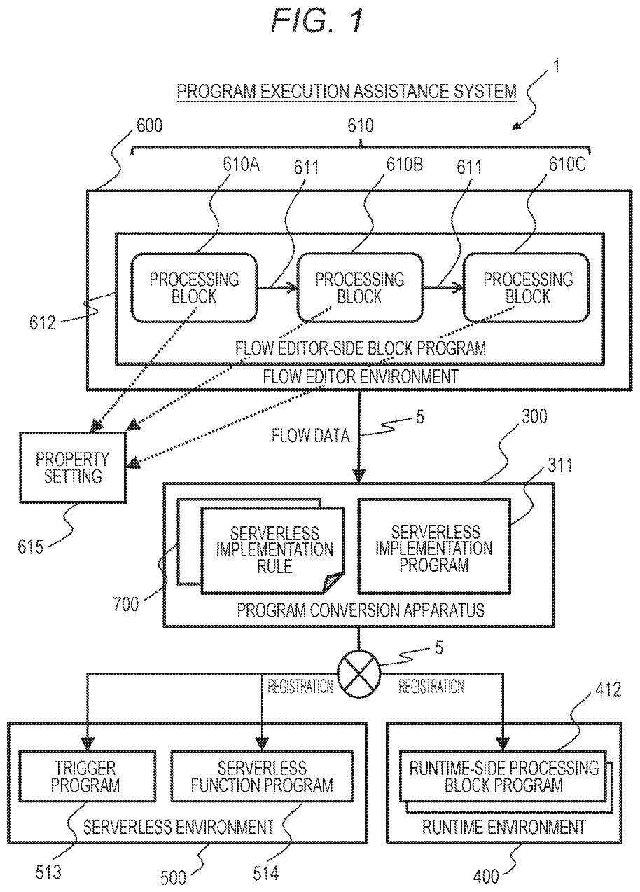

FIG. 1 is a diagram illustrating an example of the configuration of the program execution assistance system 1 of this embodiment.

The program execution assistance system 1 of this embodiment is configured to include a serverless environment 500 and a program conversion apparatus 300 (program execution assistance apparatus) in addition to the flow editor environment 600 and the runtime environment 400.

The flow editor environment 600 has the same configuration and functions as those described in FIG. 8. The runtime environment 400 has the same configuration and functions as those described in FIG. 8.

The program conversion apparatus 300 is an information processing system including one or more information processing apparatuses. The program conversion apparatus 300 is provided in a business office or a data center of a predetermined manager.

The program conversion apparatus 300 stores a serverless implementation program 311. The serverless implementation program 311 executes a predetermined conversion process based on the flow data received from the flow editor environment 600.

Specifically, when the serverless implementation program 311 receives the flow data, the serverless implementation program 311 creates registration information, which is information of a new execute instruction from the flow data, based on a serverless implementation rule 700, and transmits the created registration information to either the runtime environment 400 or the serverless environment 500. Details of the serverless implementation rule 700 will be described later.

The serverless environment 500 is an information processing system (for example, cloud) including one or more information processing apparatuses. The serverless environment 500, for example, is managed by a predetermined service provider and provides a program that can be used by each user (including a user other than the user who uses the flow editor environment 600).

Specifically, the serverless environment 500 stores a serverless function program 514 and a trigger program 513 for executing the serverless function program 514.

The trigger program 513 is executed when the registration information is received from the program conversion apparatus 300. The trigger program 513 has, for example, a specification that the process of the serverless function program 514 is executed at a predetermined timing after receiving the registration information (for example, periodically), or the serverless function program 514 is executed at a predetermined trigger (for example, timing when a REST API endpoint (URL or external function) is accessed from the outside; hereinafter, collectively referred to as REST API endpoint) after receiving the registration information.

The information processing systems in the program execution assistance system 1 are communicatively connected by a wired or wireless network 5 such as a LAN (Local Area Network), a WAN (Wide Area Network), the Internet, or a dedicated line.

Next, each information processing apparatus in the program execution assistance system 1 will be described in more detail.

<Program Conversion Apparatus>

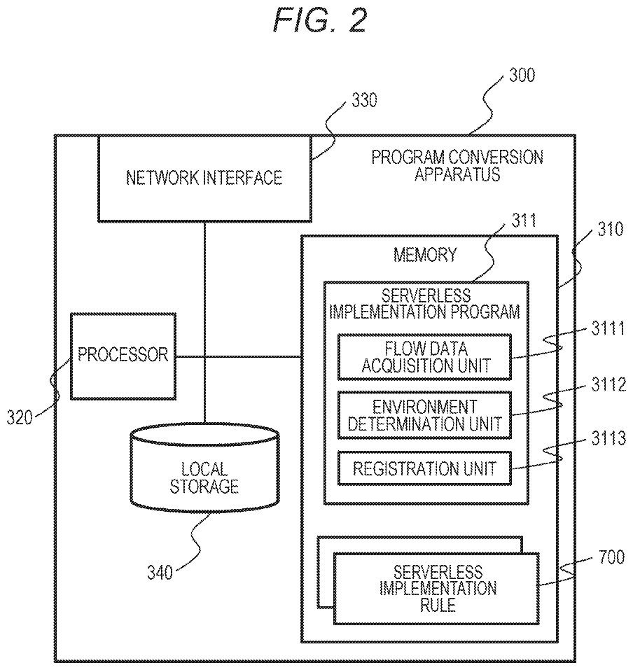

FIG. 2 is a diagram for explaining an example of the hardware configuration and functions of the program conversion apparatus 300.

The program conversion apparatus 300 includes a processor 320 (arithmetic device) such as a CPU as hardware, a memory 310 such as a RAM (Random Access Memory) and a ROM (Read Only Memory) in which software and data are expanded, a local storage 340 such as an HDD (Hard disk drive), an SSD (Solid State Drive), and a flash memory, and a network interface 330 such as a network interface card for communicating with other information processing apparatuses, which are connected to each other via a bus or the like. The program conversion apparatus 300 may include an input device such as a keyboard or a touch panel, or an output device such as a monitor or a display (both not illustrated).

The program conversion apparatus 300 stores the serverless implementation program 311 and the serverless implementation rule 700.

The serverless implementation program 311 includes a flow data acquisition unit 3111, an environment determination unit 3112, and a registration unit 3113.

The flow data acquisition unit 3111 receives flow data from the flow editor environment 600. That is, the flow data acquisition unit 3111 acquires information on the process to be executed (processing block 610) and information (property) on the attribute of the process from the flow editor environment 600.

As a specific processing procedure, first, the flow editor environment 600 receives an input of the process to be executed (processing block 610) and the property of the process from the user, and displays the received input content on a predetermined screen. Then, the flow data acquisition unit 3111 of the program conversion apparatus 300 acquires the information on the processing of the processing block 610 and the information on the property of the process based on the screen displayed in the flow editor environment 600.

Next, the environment determination unit 3112 determines an environment for executing the processing block 610 based on the serverless implementation rule 700 defining the relationship between the predetermined process and the environment for executing the predetermined process and the property of the processing block 610 acquired by the flow data acquisition unit 3111.

For example, the environment determination unit 3112 determines an environment for executing the processing block 610 based on the serverless implementation rule 700 and the information of an access location (an endpoint such as REST API) required for starting the processing of the processing block 610 as a property of the processing block 610.

Further, for example, the environment determination unit 3112 determines an environment for executing the processing block 610 based on the serverless implementation rule 700 and the information of a resource location to be accessed by the processing block 610 as a property of the processing block 610.

Specifically, for example, the environment determination unit 3112 determines an environment for executing the processing block 610 based on the serverless implementation rule 700 and the information of a write destination and a read destination of data to be accessed by the processing block 610 as a property of the processing block 610.

In addition, specifically, for example, the environment determination unit 3112 determines an environment for executing the processing block 610 based on the serverless implementation rule 700 and the information of a storage location of a program to be executed by the processing block 610 as a property of the processing block 610.

Further, the environment determination unit 3112 determines an environment for executing the processing block 610 based on the serverless implementation rule 700 and a resource efficiency as a property of the processing block 610.

The serverless implementation rule 700 defines a relationship among the processing block 610, the access location required for starting the processing of the processing block 610 (an endpoint such as REST API) as an attribute of the processing block 610, and the environment for executing the processing block 610 which is associated to the access location.

Further, the serverless implementation rule 700 defines a relationship among the processing block 610, the location of a resource to be accessed by the processing block 610 as an attribute of the processing block 610, and the environment for executing the processing block 610 which is associated to the resource location.

The serverless implementation rule 700 stores the write destination of write data of the processing block 610 or the read destination of read data of the processing block 610 as the resource location to be accessed by the processing block 610.

Further, the serverless implementation rule 700 stores the storage location of the program to be executed by the processing block 610 as the resource location to be accessed by the processing block 610.

Further, the serverless implementation rule 700 defines a relationship among the processing block 610, the resource efficiency of the processing block 610 as an attribute of the processing block 610, and the environment for executing the processing block 610 which is associated with the resource efficiency.

The registration unit 3113 transmits, to the environment determined by the environment determination unit 3112, information (registration information) for executing the program that realizes the processing block 610 in the environment.

For example, the registration unit 3113 transmits, as information for executing a program, information including the information related to the program (information in a program environment definition 521 described later) associated with the environment determined by the environment determination unit 3112.

<Runtime Environment>

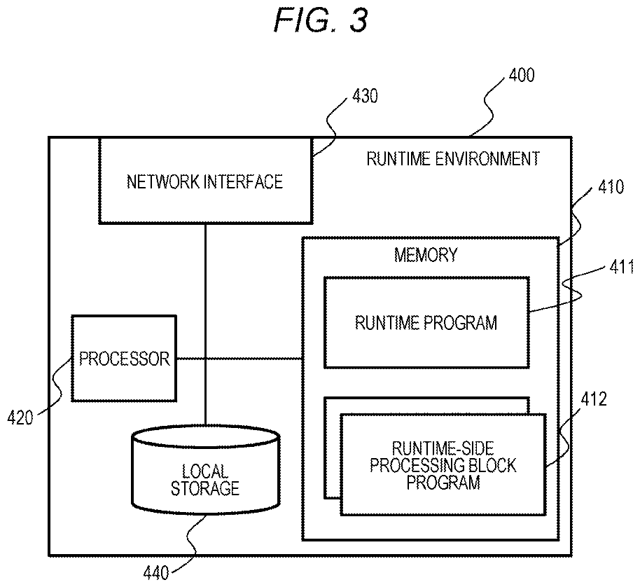

FIG. 3 is a diagram for explaining an example of the hardware configuration and functions of the runtime environment 400.

The runtime environment 400 includes a processor 420 (arithmetic device) such as a CPU as hardware, a memory 410 such as a RAM (Random Access Memory) and a ROM (Read Only Memory) in which software and data are expanded, a local storage 440 such as an HDD (Hard disk drive), an SSD (Solid State Drive), and a flash memory, and a network interface 430 such as a network interface card for communicating with other information processing apparatuses, which are connected to each other via a bus or the like. The runtime environment 400 may include an input device such as a keyboard or a touch panel, or an output device such as a monitor or a display (both not illustrated).

The runtime environment 400 stores a runtime program 411 and the runtime-side processing block program 412.

The runtime program 411 receives the flow data from the program conversion apparatus 300, and executes each of the runtime-side processing block program 412 designated in the received flow data in the order indicated by the order information of the received flow data. At this time, the runtime program 411 executes the runtime-side processing block program 412 according to the property indicated by the property information of the received flow data.

The runtime-side processing block program 412 is a program corresponding to the processing block 610, and specifically is, for example, a source code of the program. One or a plurality of runtime-side processing block programs 412 are provided so as to correspond to each processing block 610.

The runtime-side processing block program 412 may read data stored in the local storage 440 and write predetermined data in the local storage 440.

<Serverless Environment>

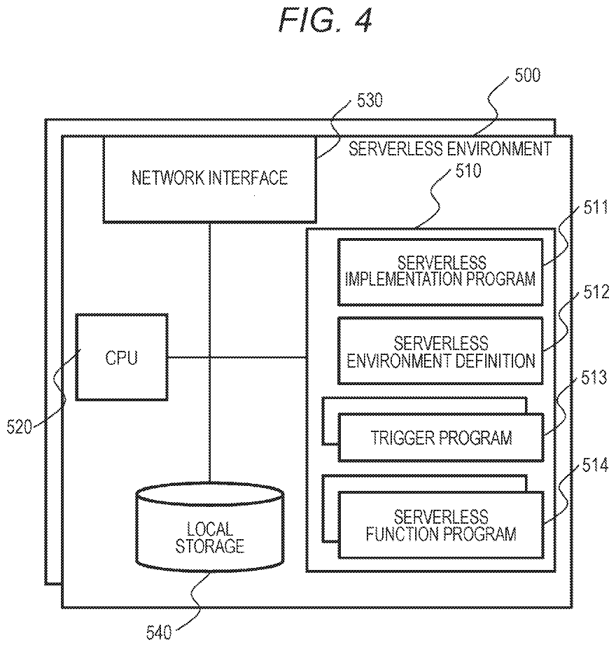

FIG. 4 is a diagram for explaining an example of the hardware configuration and functions of the serverless environment 500. The serverless environment 500 is an environment for executing a registered serverless function. Further, in the serverless environment 500, the timing of executing the serverless function can be defined.

The serverless environment 500 includes a processor 520 (arithmetic device) such as a CPU as hardware, a memory 510 such as a RAM (Random Access Memory) and a ROM (Read Only Memory) in which software and data are expanded, a local storage 540 such as an HDD (Hard disk drive), an SSD (Solid State Drive), and a flash memory, and a network interface 530 such as a network interface card for communicating with other information processing apparatuses, which are connected to each other via a bus or the like. The serverless environment 500 may include an input device such as a keyboard or a touch panel, or an output device such as a monitor or a display.

The serverless environment 500 also stores a serverless implementation program 511, the trigger program 513, the serverless function program 514, and a serverless environment definition 512.

The serverless implementation program 511 executes the trigger program 513 and the serverless function program 514. At this time, the serverless implementation program 511 allocates resources such as the processor 520, the memory 510, or the local storage 540 required executing the trigger program 513 and the serverless function program 514 to these programs.

The serverless environment definition 512 stores the specifications of the type of the trigger program 513, the endpoint where the serverless function program 514 is activated, and the function specifications of the serverless function program 514. The content of the serverless environment definition 512 differs depending on the serverless environment 500.

The trigger program 513 executes the serverless function program 514 at a designated timing. For example, the trigger program 513 periodically executes the serverless function program 514 when receiving the information indicating periodic execution. Further, for example, the trigger program 513 executes the serverless function program 514 when detecting that the access destination indicated by the information indicating a predetermined access destination (for example, an endpoint of REST API) is accessed.

The serverless function program 514 is a program that is the main body of a serverless function, and is a program (for example, source code) corresponding to the runtime-side processing block program 412. For example, the serverless function program 514 is a program including the function of the runtime-side processing block program 412. Further, for example, the serverless function program 514 is a program that executes the plurality of runtime-side processing block programs 412 in a predetermined order. The serverless function program 514 is executed according to the specifications (conditions) indicated by the serverless environment definition 512.

<Flow Editor Environment>

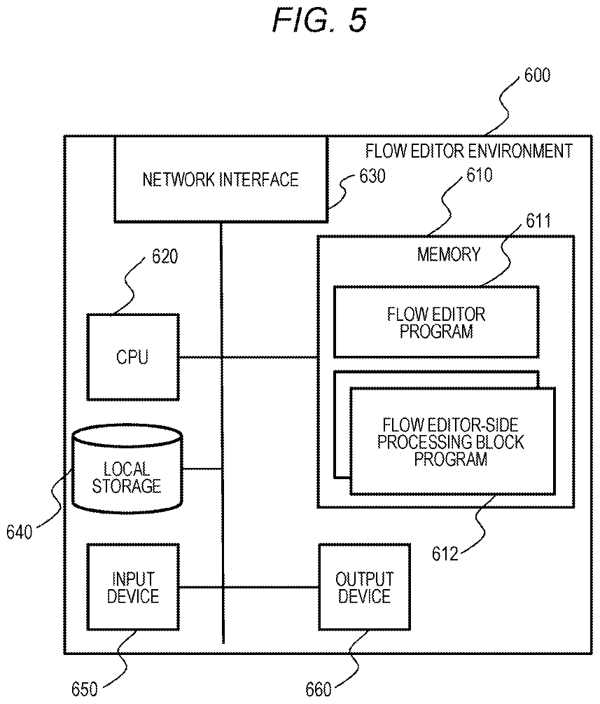

FIG. 5 is a diagram illustrating an example of the hardware configuration and functions of the flow editor environment 600. The flow editor environment 600 includes a processor 620 (arithmetic device) such as a CPU as hardware, a memory 610 such as a RAM (Random Access Memory) and a ROM (Read Only Memory) in which software and data are expanded, a local storage 640 such as an HDD (Hard disk drive), an SSD (Solid State Drive), and a flash memory, a network interface 630 such as a network interface card for communicating with other information processing apparatuses, an input device 650 such as a keyboard or a touch panel, and an output device 660 such as a monitor or a display, which are connected to each other via a bus or the like.

The flow editor environment 600 stores a flow editor program 611 and the flow editor-side processing block program 612.

The flow editor program 611 edits each processing block 610. For example, the flow editor program 611 receives an input from the user to set each processing block 610 and set the order between them. Further, the flow editor program 611 sets the property of each processing block 610 by receiving an input from the user.

The flow editor-side processing block program 612 displays an edit screen corresponding to the flow editor program 611. For example, the flow editor-side processing block program 612 displays the editing content of each processing block 610 (connection relationship between the processing blocks 610, property content, etc.) via the flow editor program 611.

The flow editor-side processing block program 612 may be read by the flow editor program 611. In this case, for example, an external program such as the runtime-side processing block program 412 of the runtime environment 400 may call the flow editor program 611.

Next, the serverless implementation rule 700 stored in the program conversion apparatus 300 will be described.

<Serverless Implementation Rule>

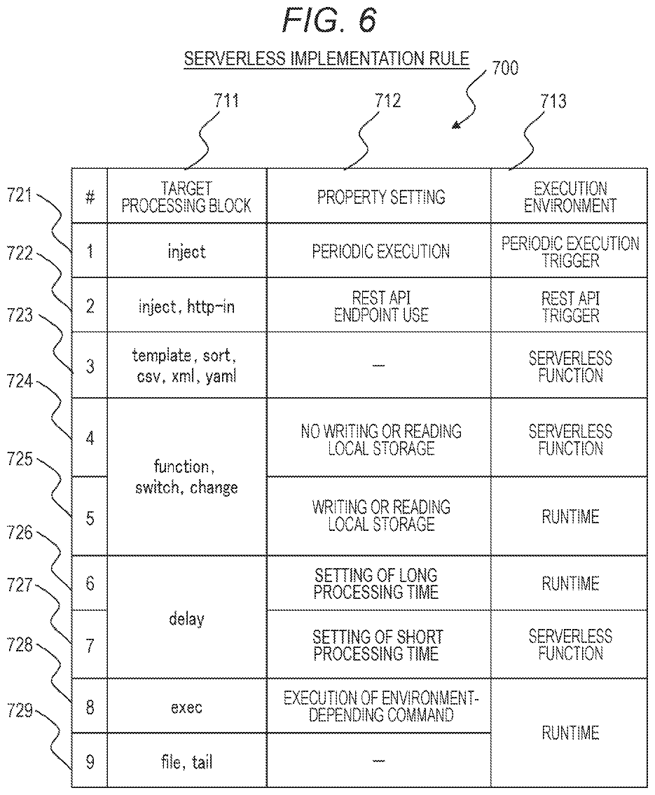

FIG. 6 is a diagram illustrating an example of the serverless implementation rule 700. The serverless implementation rule 700 is a database having at least one or more records, which includes a target processing block 711 that is information for specifying the type of the processing block 610, a property setting 712 that is information of the property set in the processing block 610 related to the target processing block 711, and an execution environment 713 that is information of an execution destination (execution environment) of the process related to the processing block 610 in a case where the property related to the property setting 712 is set to the processing block 610 related to the target processing block 711.

For example, a character string or the like representing the processing block 610 is set in the target processing block 711.

For example, “inject” is provided as the first processing block 610 of the plurality of processing blocks 610, and is provided as the processing block 610 for starting a series of flows. In the property of “inject”, there is set information on the timing of executing the function related to the processing block 610 next to the processing block 610 related to “inject”. The timing includes, for example, a timing when a predetermined input is made by the user, or a timing (periodic execution) at a time interval or time designated in advance.

Like “inject”, “http-in” is provided as the first processing block 610 among the plurality of processing blocks 610, and is provided as the processing block 610 for starting a series of flows. “http-in” is the processing block 610 using the endpoint of REST API. By executing the function related to “http-in”, a new URL is allocated to the information processing apparatus (server) that can communicate according to a protocol such as HTTP or HTTPS (designated by the property), and if this URL is accessed from the outside, the function related to the processing block 610 next to “http-in” is executed. For example, when a smartphone application refers to the database of a backend server, the REST API can be created by combining “http-in” and a database processing block.

Further, “inject” can also use the endpoint of REST API. When a predetermined property to start the process is set in “inject”, the endpoint of REST API is created. As a result, it is possible to issue a process start trigger using the user interface.

Next, in the target processing block 711, the processing block 610 for performing a process that does not depend on the runtime environment 400 and the serverless environment 500 can be set (“template”, “sort”, “csv”, “xml”, and “yaml”).

“template” of these processes specified information. When “template” receives the data of a predetermined processing start instruction from the previous processing block 610, “template” passes the information set in the property (for example, text information) to the subsequent processing block 610. When receiving array data from the previous processing block 610, “sort” sorts each data in the array data according to the condition set in the property, and passes the sorted array data to the subsequent processing block 610. The “csv”, “xml”, and “yaml” convert the data received from the previous processing block 610 into CSV format, XML format, and YAML format data, respectively, and pass the converted data to the subsequent processing block 610.

Further, in the target processing block 711, the processing block 610 that may involve reading and writing of data from/to the local storage 440 of the runtime environment 400 can be set (“function”, “switch”, and “change”).

The source code of the program is set in each property of “function”, “switch”, and “change”. “function”, “switch”, and “change” execute each process set in the property, a conditional branch process set in the property, and data substitution process or conversion process set in the property.

Further, in the target processing block 711, the processing block 610 that particularly consumes the resources of the serverless environment 500 can be set (“delay”).

“delay” is started when predetermined data is received from the previous processing block 610, and after the operation is stopped for a period set in the property, the data is passed to the subsequent processing block 610.

Further, in the target processing block 711, the processing block 610 that executes a function (program) unique to the runtime environment 400 can be set (exec). “exec” executes a command set in the property. This command may depend on an execution environment (OS etc.).

Further, in the target processing block 711, the processing block 610 for accessing a file system of the runtime environment 400 can be set (file, tail).

“file” reads the contents of a file on the file system set in the property or creates a file in that file system. “tail” reads the data at the end of a file on the file system.

Next, in the property setting 712, for example, information such as “Periodic execution”, “Using REST API endpoint”, “Neither writing nor reading local storage”, “Writing or reading local storage”, “Setting large processing time”, “Setting small processing time”, and “Environment-dependent command execution” is set. These details will be described later.

Next, in the execution environment 713, information such as “Periodic execution trigger”, “REST API trigger”, “Serverless function”, or “Runtime” is set.

When the execution environment 713 is the “Periodic execution trigger”, the trigger program 513 of the serverless environment 500 related to the target processing block 711 is set as the execution environment. In this case, the trigger program 513 calls the serverless function program 514 that performs the process of periodically calling the subsequent processing block 610 of the target processing block 711.

When the execution environment 713 is “REST API trigger”, the trigger program 513 of the serverless environment 500 related to the target processing block 711 is set as the execution environment. In this case, the trigger program 513 calls the serverless function program 514 that performs the process of calling the subsequent processing block 610 of the target processing block 711 when the endpoint of REST API is accessed from the outside.

When the execution environment 713 is “Serverless function”, the serverless function program 514 of the serverless environment 500 related to the target processing block 711 is set as the execution environment. In this case, the serverless function program 514 causes the runtime-side processing block program 412 to be executed with the property related to the target processing block 711. If there is the subsequent processing block 610 of the target processing block 711, the serverless function program 514 for executing the serverless function program 514 related to the processing block 610 is executed.

When the execution environment 713 is “Runtime”, the runtime-side processing block program 412 of the runtime environment 400 related to the target processing block 711 is set as the execution environment. In this case, when there is the subsequent processing block 610 of the target processing block 711, a predetermined program for executing the runtime-side processing block program 412 related to the processing block 610 (a program stored in the runtime environment 400) is executed.

Each function of each information processing apparatus in the program execution assistance system 1 described above is realized by dedicated hardware, or by reading and executing the programs which are stored in the memories 320, 420, 520, and 620 or the local storages 340, 440, 540, and 640 by the processors 320, 420, 520, and 620. Further, each program may be recorded in advance in a recording medium that can be read by each information processing apparatus, or may be introduced when necessary via a storage medium or a predetermined communication network.

<Serverless Implementation Process>

Next, the process in the program execution assistance system 1 will be described.

The program conversion apparatus 300 executes a serverless implementation process in which the serverless environment 500 or the runtime environment 400 is instructed to execute a program suitable for each environment in order to execute the process corresponding to the flow of the processing block 610 created by the flow editor environment 600.

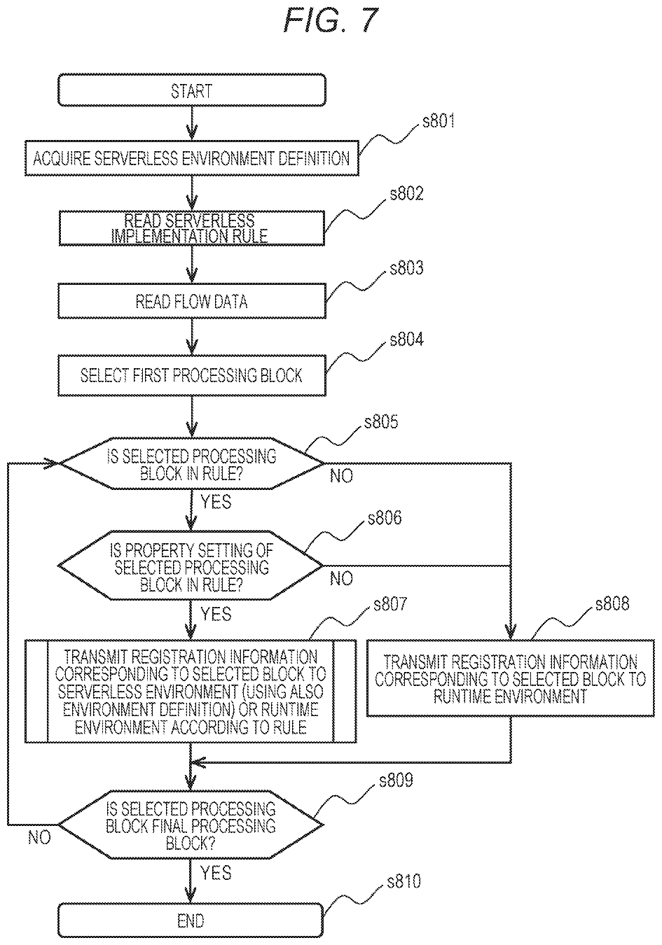

FIG. 7 is a flowchart for explaining an example of the serverless implementation process. The serverless implementation process is started, for example, at a trigger when the program conversion apparatus 300 receives the flow data from the flow editor environment 600.

First, the flow data acquisition unit 3111 of the program conversion apparatus 300 receives the serverless environment definition 512 from the serverless environment 500 (s801). Further, the flow data acquisition unit 3111 reads the serverless implementation rule 700 (s802).

The flow data acquisition unit 3111 develops the received flow data on the memory 310, and thereby acquiring the type of each processing block 610 (block specifying information), the property of each processing block 610 (property information), and the processing order of each processing block 610 (order information) (s803).

The environment determination unit 3112 selects the first processing block 610 from the processing blocks 610 acquired in s803 (s804).

The environment determination unit 3112 retrieves a record of the currently selected processing block 610 (hereinafter, referred to as a selected block) from the serverless implementation rule 700 (s805).

Specifically, for example, the environment determination unit 3112 acquires from the serverless implementation rule 700 all records in which the information of the selected block is set in the target processing block 711.

When the selected block can be retrieved from the serverless implementation rule 700 (s804: YES), the environment determination unit 3112 executes the process of s806 described below. When the selected block cannot be retrieved from the serverless implementation rule 700 (s804: NO), the selected block cannot be made serverless, so the environment determination unit 3112 executes the process of s808 described below in order to use the runtime environment 400.

In s806, the environment determination unit 3112 retrieves the property related to the selected block from the serverless implementation rule 700 while analyzing the property of the selected block.

Specifically, for example, the environment determination unit 3112 retrieves a record in which the property information of the selected block is set in the property setting 712 among the records retrieved in s805.

When the environment determination unit 3112 can retrieve the property related to the selected block (s806: YES), the registration unit 3113 executes the process of s807 described below. When the environment determination unit 3112 cannot retrieve the property related to the selected block (s806: NO), the selected block cannot be made serverless, so the registration unit 3113 executes the process of s808 described below.

In s807, the registration unit 3113 creates information (registration information) for executing the processing of the selected block in the serverless environment 500 or the runtime environment 400, and transmits the created registration information to the serverless environment 500 or the runtime environment 400.

Specifically, for example, the registration unit 3113 transmits registration information instructing to execute the process related to the selected block in the environment indicated by the execution environment 713 of the record retrieved in s806, to the environment.

For example, when the execution environment is the runtime environment 400, the registration unit 3113 creates registration information indicating that the runtime-side processing block program 412 corresponding to the processing of the selected block is executed in the runtime environment 400 (for example, the runtime-side processing block program 412 is created as registration information). Further, the registration unit 3113 includes the order information acquired in s803 to the registration information.

When the subsequent processing block 610 exists in the selected block, the registration unit 3113 includes the information, which indicates that the runtime-side processing block program 412 related to the processing block 610 is executed, in the registration information.

On the other hand, when the execution environment is the serverless environment 500, the registration unit 3113 performs a predetermined conversion on the registration information indicating that the runtime-side processing block program 412 corresponding to the processing of the selected block is executed, based on the serverless environment definition 512 acquired in s802 so as to create the registration information (for example, the program obtained by converting the runtime-side processing block program 412 based on the information of the serverless environment definition 512 is included in the registration information). In addition, the registration unit 3113 converts the order information acquired in s803 into a data format corresponding to the serverless environment 500, and then includes it in the registration information.

When the processing of the selected block uses an endpoint such as REST API, the registration unit 3113, for example, wraps the runtime-side processing block program 412 with predetermined data based on the serverless environment definition 512 in order to convert the runtime-side processing block program 412 into the serverless function program 514 of the specification called via the endpoint such as REST API and use this as registration information, and uses the wrapped program (serverless function program 514) as the registration information. This is because the serverless function program 514 normally needs to be called via an endpoint such as REST API because of the specifications of the serverless environment 500.

Further, in this case, the registration unit 3113 converts the order information acquired in s803 into order information of the method defined by the serverless environment definition 512, and includes the converted order information in the registration information. Therefore, the serverless function program 514 can be correctly executed in the order indicated by the flow data.

After the above process of s807 is completed, the process of s809 is executed.

On the other hand, in s808, the registration unit 3113 creates registration information for causing the runtime environment 400 to execute the process corresponding to the selected block, and transmits the created registration information to the runtime environment 400.

Specifically, for example, the registration unit 3113 creates registration information indicating that the runtime-side processing block program 412 related to the selected block is executed in the runtime environment 400 as similarly done in s807.

In this case, the registration unit 3113 includes endpoint information such as REST API for calling the runtime-side processing block program 412 related to the selected block in the registration information. After that, the process of s809 is executed.

In s809, the registration unit 3113 determines whether the currently selected block is the last processing block 610 indicated by the flow data.

If the currently selected block is the last processing block 610 (s809: YES), the registration unit 3113 ends the processing (s810).

On the other hand, when the currently selected block is not the last processing block 610 (s809: NO), the registration unit 3113 sets the currently selected block as the next processing block 610, and then repeats the subsequent processes of s805.

Here, a specific example of the serverless implementation process will be described for each type of the selected block.

<“Inject”—Periodic Execution>

When the selected block is “inject”, the environment determination unit 3112 analyzes the content of the property of the selected block (s806).

When the information indicating the periodic execution is set in the property of the selected block (s806: YES), the registration unit 3113 creates the registration information having the trigger program 513 of the serverless environment 500 as an execution environment based on a record 721 (“Periodic execution trigger”) of the serverless implementation rule 700, and transmits the created registration information to the serverless environment 500 (s807).

This registration information includes, for example, a content that the trigger program 513 of the serverless environment 500 is instructed to execute the serverless function program 514 corresponding to “inject” at a periodic execution timing indicated by the property of the selected block. This allows the process corresponding to “inject” to operate in the serverless environment 500.

If the serverless implementation program 511 does not correspond to the timing (periodic execution) indicated by the selected block (s806: NO), this “inject” process cannot be executed in the serverless environment 500, so the registration unit 3113 executes the process of s808 (the registration information indicating that the runtime-side processing block program 412 related to “inject” is executed is transmitted to the runtime environment 400).

<“Inject”, “Http-In”—Using Endpoint>

When the selected block is “inject” or “http-in”, the environment determination unit 3112 analyzes the content of the property of the selected block (s806).

When it is determined that the information indicating that the REST API endpoint is used is set in the property of the selected block (s806: YES), the registration unit 3113 creates the registration information having the trigger program 513 of the serverless environment 500 as an execution environment based on a record 722 (“REST API trigger”) of the serverless implementation rule 700, and transmits the created registration information to the serverless environment 500 (s807).

This registration information includes, for example, a content that the trigger program 513 of the serverless environment 500 is instructed to create an endpoint of REST API. In addition, this registration information includes a content that the serverless function program 514, which executes the runtime-side processing block program 412 related to the selected block (“inject” or “http-in”) under the condition indicated by the property of the selected block is executed in the serverless environment 500 (for example, the serverless function program 514 corresponding to the runtime-side processing block program 412 is registered in the serverless environment 500). As a result, the processing block 610 that is the endpoint of REST API can be executed in the serverless environment 500.

If the property of the selected block, “inject” or “http-in”, specifies a communication method that the serverless environment 500 does not support, the registration unit 3113 may transmit the registration information to the runtime environment 400. For example, if a DELETE method is used in HTTP or HTTPS communication in the “http-in” property, but the trigger program 513 of the serverless environment 500 supports only a GET method and a POST method, the registration unit 3113 registers the registration information related to the runtime-side processing block program 412 in the runtime environment 400. As a result, the DELETE method is executed normally.

<“Template”, “Sort”, “Csv”, “Xml”, “Yaml”>

When the selected block is “template”, “sort”, “csv”, “xml”, or “yaml”, the registration unit 3113 creates the registration information having the serverless function program 514 of the serverless environment 500 as an execution environment based on a record 723 (“serverless function”) of the serverless implementation rule 700 regardless of the property of the selected block (s806: YES), and transmits the created registration information to the serverless environment 500 (s807).

This registration information includes a content that the serverless function program 514 of the serverless environment 500 corresponding to the selected block is executed (for example, the runtime-side processing block program 412 related to “template” or the like is registered in the serverless environment 500 as the serverless function program 514). This allows the processes corresponding to “template”, “sort”, “csv”, “xml”, and “yaml” to operate in the serverless environment 500. The reason why the serverless environment 500 is used as the execution environment in this way is that the selected block in this case is always stateless processing (processing that does not rewrite data on an external storage or memory), so that it is appropriate to make it serverless regardless of the content of the property.

<Function>

When the selected block is “function”, the environment determination unit 3112 analyzes the property of the selected block, so that it is determined whether the process indicated by the property performs referring to data in the local storage 440 or writing data to the local storage 440 (s806).

If the process is neither referring to data nor writing data, the processing of the selected block is stateless. Therefore, the registration unit 3113 creates registration information having the serverless function program 514 of the serverless environment 500 as an execution environment based on a record 724 (“serverless function”) of the serverless implementation rule, and transmits the created registration information to the serverless environment 500 (s807).

This registration information includes a content that the serverless function program 514 corresponding to the runtime-side processing block program 412 related to “function” is executed (for example, the runtime-side processing block program 412 related to “function” as the serverless function program 514 in the serverless environment 500).

On the other hand, when the process performs referring to data or writing data, the registration unit 3113 creates registration information having the runtime-side processing block program 412 of the runtime environment 400 as an execution environment based on a record 725 (“runtime”) of the serverless implementation rule 700, and transmits the created registration information to the runtime environment 400 (s807).

This registration information includes a content that the runtime-side processing block program 412 related to “function” is caused to be executed by the runtime environment 400 (for example, the runtime-side processing block program 412 related to “function” is registered in the runtime environment 400). The reason why the runtime environment 400 is used as the execution environment in this way is that the data processing of the selected block and the processing of the other processing block 610 for the data may operate in parallel, and the processing results on the data may be inconsistent.

<Switch>

Next, when the selected block is “switch”, the environment determination unit 3112 analyzes the property of the selected block to determine whether the data of the local storage 440 is used (referred or written) when performing a conditional branch (s806).

If the process does not use the data in the local storage 440, the processing of the selected block is stateless. Therefore, the registration unit 3113 creates registration information having the serverless function program 514 of the serverless environment 500 as an execution environment based on a record 724 (“serverless function”) of the serverless implementation rule 700, and transmits the created registration information to the serverless environment 500 (s807).

This registration information includes a content that the serverless function program 514 corresponding to the runtime-side processing block program 412 related to “switch” is executed (for example, the runtime-side processing block program 412 related to “switch” as the serverless function program 514 in the serverless environment 500).

On the other hand, when the process uses the data in the local storage 440, the registration unit 3113 creates registration information having the runtime-side processing block program 412 of the runtime environment 400 as an execution environment based on a record 725 (“runtime”) of the serverless implementation rule 700, and transmits the created registration information to the runtime environment 400 (s807).

This registration information includes a content that the runtime-side processing block program 412 related to “switch” is caused to be executed (for example, the runtime-side processing block program 412 related to “switch” is registered in the runtime environment 400). The reason why the runtime environment 400 is used as the execution environment in this way is that if the process related to the selected block that uses the data in the local storage 440 and other processes are operating in parallel, the result of the conditional branching in the process related to the selected block may differ due to the data processing of other processes, therefore, the consistent operation can be guaranteed by using the runtime environment 400.

<Change>

Next, when the selected block is “change”, the environment determination unit 3112 analyzes the property of the selected block to determine whether the selected block reads data from the local storage 440 in the substitution process or the replacement process, and whether the data is written to the local storage 440 (s806).

If the selected block does not read data from the local storage 440 and does not write data to the local storage 440, the selected block is stateless. Therefore, the registration unit 3113 creates registration information having the serverless function program 514 of the serverless environment 500 as an execution environment based on the record 724 (“serverless”) of the serverless implementation rule 700, and transmits the created registration information to the serverless environment 500 (s807).

This registration information includes a content that the serverless function program 514 corresponding to the runtime-side processing block program 412 related to “change” is executed (for example, the runtime-side processing block program 412 related to “change” as the serverless function program 514 in the serverless environment 500).

On the other hand, when the selected block reads data from the local storage 440 or writes data to the local storage 440 (s806: YES), the registration unit 3113 creates registration information having the runtime-side processing block program 412 of the runtime environment 400 as an execution environment based on the record 725 (“runtime”) of the serverless implementation rule 700, and transmits the created registration information to the runtime environment 400 (s807).

This registration information includes a content that the runtime-side processing block program 412 related to “change” is caused to be executed (for example, the runtime-side processing block program 412 related to “change” is registered in the runtime environment 400). The reason why the runtime environment 400 is used as the execution environment in this way is that the data to be processed by the selected block in this case may depend on the data written by other processes, therefore, the consistent operation can be guaranteed by using the runtime environment 400.

<Delay>

Next, when the selected block is “delay”, the environment determination unit 3112 analyzes the property of the selected block to determine whether information for stopping for a predetermined time or more is set in the property (s806).

When the information for stopping for a predetermined time or more is set in the property, the registration unit 3113 creates registration information having the runtime-side processing block program 412 of the runtime environment 400 as an execution environment based on a record 726 (“runtime”) of the serverless implementation rule 700, and transmits the created registration information to the runtime environment 400 (s807).

This registration information includes a content that the runtime-side processing block program 412 related to “delay” is executed (for example, the runtime-side processing block program 412 related to “delay” is registered in the runtime environment 400). The reason why the runtime environment 400 is used as the execution environment in this way is that the serverless environment 500 is generally a system in which the user is charged depending on the length of time the process is executed and the amount of resources used, therefore, if the time is long, there is little merit in reducing the resource usage time by making the serverless implementation (resource efficiency decreases).

On the other hand, when the information for stopping for a predetermined time or more is not set in the property, the registration unit 3113 creates registration information having the serverless function program 514 of the serverless environment 500 as an execution environment based on a record 727 (“serverless”) of the serverless implementation rule 700, and transmits the created registration information to the serverless environment 500 (s807).

This registration information includes a content that the serverless function program 514 corresponding to the runtime-side processing block program 412 related to “delay” is executed (for example, the runtime-side processing block program 412 related to “delay” as the serverless function program 514 in the serverless environment 500). As described above, the reason why the serverless environment 500 is used as the execution environment is that the resource efficiency is not significantly affected even if being serverless because the stopping time is short.

<Exec>

Next, when the selected block is “exec”, the environment determination unit 3112 analyzes the property of the selected block and determines whether a command that the serverless environment 500 does not support (cannot execute) is included in the property (s806).

If a command that the serverless environment 500 does not support is included, the registration unit 3113 creates registration information having the runtime-side processing block program 412 of the runtime environment 400 as an execution environment based on a record 728 (“runtime”) of the serverless implementation rule 700, and transmits the created registration information to the runtime environment 400 (s807).

This registration information includes a content that the runtime-side processing block program 412 related to “exec” is executed (for example, the runtime-side processing block program 412 related to “exec” is registered in the runtime environment 400). The reason why the runtime environment 400 is used as the execution environment in this way is that if the serverless environment 500 is running on a different OS from the runtime environment 400 (if the execution target program of “exec” depends on the environment), the command may be not executed correctly in the serverless environment 500.

On the other hand, if there is no command that the serverless environment 500 does not support, the registration unit 3113 creates registration information having the serverless function program 514 of the serverless environment 500 as an execution environment, and transmits the created registration information to the serverless environment 500 (s807).

This registration information includes a content that the serverless function program 514 corresponding to the runtime-side processing block program 412 related to “exec” is executed (for example, the runtime-side processing block program 412 related to “exec” as the serverless function program 514 in the serverless environment 500).

The serverless implementation program 511 of the serverless environment 500 is instructed to execute the serverless function program 514 corresponding to “exec”.

<File, Tail>

Next, when the selected block is “file” or “tail”, the registration unit 3113 creates registration information having the runtime-side processing block program 412 of the runtime environment 400 as an execution environment based on the records 728 and 729 (“runtime”) of the serverless implementation rule 700 regardless of the property of the selected block (s806), and transmits the created registration information to the runtime environment 400 (s807).

This registration information includes a content that the runtime-side processing block program 412 related to “file” or “tail” is executed (for example, the runtime-side processing block program 412 related to “file” or “tail” is registered in the runtime environment 400). The reason why the runtime environment 400 is used as the execution environment is that the file system accessed by the runtime-side processing block program 412 corresponding to “file” or “tail” may be accessed simultaneously by other processes (because it is stateful).

When it is determined that the information indicating that a file of a predetermined external database other than the runtime environment 400 is accessed is set to the property related to “file” or “tail”, the registration unit 3113 may use the serverless function program 514 of the serverless environment 500 as the execution environment instead of the runtime environment 400. The reason for this is that when accessing such an external database, the consistency of files in the external database is guaranteed.

As described above, according to the program execution assistance apparatus of this embodiment, the program conversion apparatus 300 acquires the processing block 610 and its property, determines an environment for executing a program to realize the processing block 610 based on the serverless implementation rule 700 defying the relationship between a predetermined process and an environment (serverless environment 500 or runtime environment 400) for executing the process, and transmits, to the determined environment, the registration information for executing the program that realizes the processing block 610 in the environment. Therefore, it is possible to cause the serverless implementation rule 700 to execute a program for realizing a series of processes related to the processing block 610 under an appropriate environment.

As described above, according to the program execution assistance apparatus of this embodiment, it is possible to execute a desired process under an efficient execution environment.

For example, when a large number of flows of the processing block 610 are accumulated by the flow editor environment 600 corresponding to the runtime environment 400 and the user wants to migrate these flows to the serverless environment 500 such as a cloud, the user can transfer and execute the processing block 610 appropriate among the flows of the processing block 610 without performing a complicated work of appropriately modifying the flow related to the accumulated processing block 610 for the serverless environment 500. As a result, the process by the dedicated server can be easily made serverless. In addition, this makes the resource usage of the dedicated server more efficient, and makes it possible to enjoy more of the merit of scaling by the dedicated server.

Hitherto, the embodiments for carrying out the invention have been specifically described. However, the invention is not limited to the above embodiments, and various changes can be made in a scope not departing from the spirit.

For example, various data formats such as the serverless implementation rule 700 described in this embodiment may be arbitrary formats and are not limited to database formats.

Also, a plurality of runtime environments 400 or serverless environments 500 may be provided. In this case, the serverless environment definition 512 may be different depending on the serverless environment 500.

Further, a plurality of serverless implementation rules 700 may be provided, and may be set differently, for example, in view of the content of the cloud service in the serverless environment 500, the cost, the performance of the information processing apparatus, and the like. Then, the program conversion apparatus 300 may switch these serverless implementation rules 700 according to the runtime environment 400 or the serverless environment 500.

Further, the transmission of the registration information in the serverless implementation process may be sequentially performed for each processing block 610, or may be performed after specifying the execution environment for all the processing blocks 610 in order to reduce the load on the network 5.

Further, in this embodiment, it is assumed that there is a flow editor environment 600 capable of visually setting as a system for generating flow data. However, if flow data can be generated, any embodiment other than the flow editor environment 600 may be used.

Further, in this case, the format of the flow data does not necessarily need to correspond totally to the runtime environment 400, and the registration information received by the runtime environment 400 only has to correspond to the runtime environment 400.

According to the description of this specification, at least the following will be apparent. That is, in the program execution assistance apparatus according to this embodiment, the predetermined rule defines the relationship among the predetermined process, an access location required for starting the predetermined process as an attribute of the predetermined process, and the environment for executing the predetermined process which is associated to the access location. In the environment determination process, the arithmetic device may determine an environment for executing the execution target process based on the predetermined rule and information of an access location required for starting the execution target process as an attribute of the execution target process.

Thus, the program conversion apparatus 300 can execute the execution target process (for example, “inject”, “http-in”) under an appropriate environment based on a trigger by using the serverless implementation rule 700 related to the information (for example, an endpoint such as REST API) of the access location required for starting the process.

Further, in the program execution assistance apparatus according to this embodiment, the predetermined rule defines the relationship among the predetermined process, a resource location to be accessed by the predetermined process as an attribute of the predetermined process, and an environment for executing the predetermined process which is associated to the resource location. In the environment determination process, the arithmetic device may determine an environment for executing the execution target process based on the predetermined rule and the information of a resource location to be accessed by the execution target process as an attribute of the execution target process.

In this way, even when the execution target process is executed in any environment by using the serverless implementation rule 700 related to the location of a resource at the access destination, which is a factor that is particularly apt to depend on the environment, the program conversion apparatus 300 can execute the process in an appropriate environment without hindering the resource efficiency.

Further, in the program execution assistance apparatus of this embodiment, the predetermined rule stores a write destination of data to be written by the predetermined process or a read destination of data to be read by the predetermined process as the resource location to be accessed by the predetermined process. In the environment determination process, the arithmetic device may determine an environment for executing the execution target process based on the predetermined rule and the information of the write destination of the data or the read destination of the data in the execution target process as an attribute of the execution target process.

As described above, even when the execution target processes (for example, “function”, “switch”, “change”, “file”, and “tail”) are executed in any environment, the program conversion apparatus 300 can correctly execute these processes related to data access by using the serverless implementation rule 700 related to the data write destination or the data read destination, which is a factor that is particularly apt to depend on the environment.

Further, in the program execution assistance apparatus of this embodiment, the predetermined rule stores a storage location of a program to be executed by the predetermined process as the resource location to be accessed by the predetermined process. In the environment determination process, the arithmetic device may determine an environment for executing the execution target process based on the predetermined rule and the information of a storage location of a program to be executed by the execution target process as an attribute of the execution target process.

In this way, even when the execution target process (for example, “exec”) is executed in any environment by using the serverless implementation rule 700 related to the storage location of a program at an execution destination, which is a factor that is particularly apt to depend on the environment, the program conversion apparatus 300 can correctly execute the called program.

Further, in the program execution assistance apparatus according to this embodiment, the predetermined rule defines the relationship among the predetermined process, a resource efficiency of the predetermined process as an attribute of the predetermined process, and an environment for executing the predetermined process which is associated to the resource efficiency. In the environment determination process, the arithmetic device may determine an environment for executing the execution target process based on the predetermined rule and a resource efficiency as attribute information of the execution target process.

In this way, the program conversion apparatus 300 can execute the execution target processes (for example, “template”, “sort”, “csv”, “xml”, “yaml”, and “delay”) in an environment, where the resource efficiency can be optimized, by using the resource efficiency of the process and the serverless implementation rule 700 related to the environment corresponding to the resource efficiency.

In addition, in the program execution assistance apparatus of this embodiment, the arithmetic device transmits information which includes information associated to the determined environment and related to the program as information for executing the program in the registration process.

By doing so, for example, the program conversion apparatus 300 transmits the registration information using the serverless environment definition 512, so that even in the serverless environment 500 having a specification different from the runtime environment 400, the execution target process can be surely executed.

Further, in the program execution assistance apparatus of this embodiment, in the flow data acquisition process, the arithmetic device may receive an input of a process to be executed and an attribute of the process from the user, and acquire the information of the execution target process and the attribute information of the process based on a predetermined screen displayed on a predetermined device that executes an edit process to display the received input content in the screen.

In this way, with the use of the flow data from the system (for example, the flow editor environment 600) that sets the information of the process by screen input, the user can easily create a series of execution target processes visually, and can move and execute an appropriate process out of a series of created and accumulated processes to the serverless environment 500.

Thereby, a large number of flows created using the flow editor environment 600 can be easily moved to the serverless environment 700.

What is claimed is:

1. A program execution assistance apparatus, comprising an arithmetic device that executes
a flow data acquisition process for acquiring information of an execution target process and attribute information of the process,
an environment determination process for determining an environment for executing the execution target process based on a predetermined rule that defines a relationship between a predetermined process and an environment for executing the predetermined process, and the acquired attribute information, and
a registration process for transmitting, to the determined environment, information for executing a program that realizes the execution target process in the environment.

2. The program execution assistance apparatus according to claim 1, wherein
the predetermined rule defines a relationship among the predetermined process, an access location required for starting the predetermined process as an attribute of the predetermined process, and an environment for executing the predetermined process which is associated to the access location, and
in the environment determination process, the arithmetic device determines an environment for executing the execution target process based on the predetermined rule and information of an access location required for starting the execution target process as an attribute of the execution target process.

3. The program execution assistance apparatus according to claim 1, wherein
the predetermined rule defines a relationship among the predetermined process, a resource location to be accessed by the predetermined process as an attribute of the predetermined process, and an environment for executing the predetermined process which is associated to the resource location, and
the arithmetic device determines an environment for executing the execution target process in the environment determination process based on the predetermined rule and information of a resource location to be accessed by the execution target process as an attribute of the execution target process.

4. The program execution assistance apparatus according to claim 3, wherein
the predetermined rule stores a write destination of data to be written by the predetermined process or a read destination of data to be read by the predetermined process as a resource location to be accessed by the predetermined process, and
in the environment determination process, the arithmetic device determines an environment for executing the execution target process based on the predetermined rule and information of the write destination of the data or the read destination of the data in the execution target process as an attribute of the execution target process.

5. The program execution assistance apparatus according to claim 3, wherein
the predetermined rule stores a storage location of a program to be executed by the predetermined process as a resource location to be accessed by the predetermined process, and
in the environment determination process, the arithmetic device determines an environment for executing the execution target process based on the predetermined rule and information of a storage location of a program to be executed by the execution target process as an attribute of the execution target process.

6. The program execution assistance apparatus according to claim 1, wherein
the predetermined rule defines a relationship among the predetermined process, a resource efficiency of the predetermined process as an attribute of the predetermined process, and an environment for executing the predetermined process which is associated to the resource efficiency, and
in the environment determination process, the arithmetic device determines an environment for executing the execution target process based on the predetermined rule and a resource efficiency as attribute information of the execution target process.

7. The program execution assistance apparatus according to claim 1, wherein
the arithmetic device transmits information which includes information associated to the determined environment and related to the program as information for causing the arithmetic device to execute the program in the registration process.

8. The program execution assistance apparatus according to claim 1, wherein
in the flow data acquisition process, the arithmetic device receives an input of an execution target process and an attribute of the process from a user, and acquires information of the execution target process and attribute information of the process based on a predetermined screen displayed on a predetermined device that executes an edit process to display a received input content in the screen.

9. A program execution assistance method for an information processing apparatus that executes
a flow data acquisition process for acquiring information of an execution target process and attribute information of the process,
an environment determination process for determining an environment for executing the execution target process based on a predetermined rule that defines a relationship between a predetermined process and an environment for executing the predetermined process, and the acquired attribute information, and
a registration process for transmitting, to the determined environment, information for executing a program that realizes the execution target process in the environment.
